(19) United States
(12) Patent Application Publication
(10) Pub. No.: US 2016/0115984 A1
(43) Pub. Date: Apr. 28, 2016

(54) Mounting Element

(71) Applicant: Martin SUCHOMEL, Brno (CZ)

(72) Inventor: Martin SUCHOMEL, Brno (CZ)

(21) Appl. No.: 14/890,748

(22) PCT Filed: Apr. 11, 2014
(86) PCT No.: PCT/CZ2014/000036

§ 371 Date: Nov. 12, 2015

(30) Foreign Application Priority Data
May 13, 2013 (CZ) PV2013-348

(51) Int. Cl. F16B 9/02

(52) U.S. Cl. CPC F16B 9/023

(57) ABSTRACT

The mounting element consists of body (1) with shoulder (2), where body (I) is provided with at least one lateral groove (3) to form flexible edge portion (4) of body (1). At least one hole (5) is formed in shoulder (2) with a tapered run-out extending in the axis of lateral groove (3). This hole (5) is designed for expansion element (6) and can be threaded. At least one mounting hole (7) is formed in shoulder (2) for mounting another structural component. Flexible edge portions (4) on the outer circumference are preferably roughened or provided with splines or with hard surface coating to increase the strength of the shaped joint.

### FIELD OF THE INVENTION

The invention relates to a mounting element for releasable connections, which is particularly suitable for closed metallurgical profiles. The mounting element exhibits strength characteristics, while it can be installed without the use of special technology, such as welding, or without the use of special tools, which are necessary in pressing. In addition, it contains appropriate areas for the mounting of other structural elements, such as wheels, feet, joints, and so on.

### BACKGROUND OF THE INVENTION

Currently, only plastic plugs to metallurgical profiles are available, where the holding works on the principle of the friction of plastic plates on the walls of the profile; after being mounted and dismounted, they are unable to reliably hold again. These elements primarily serve for aesthetic and safety-related purposes—to cover sharp edges of the profile, and for covering purposes—to prevent easy ingress of dirt and/or water into the profile. There are designs with a moulded nut for the installation of, for example, an adjustable leg, but these mounting elements are not strong and are suitable only for light loads. Moreover, they are not able to withstand tensile loads in the longitudinal direction to the profile.

Designs of structural joints in the shape of cubes or balls are also known, provided with through or countersunk holes for inserting the parts being connected. The disadvantage of these solutions is the complexity of their manufacture, which requires a greater number of moulds. Another disadvantage of the known solutions is that none of these parts has resolved an issue of locking not allowing unintentional disconnection of the assembly.

If there is a requirement for a strength function of such a mounting element, it is usually necessary first to manufacture it as a separate metal piece and then to attach it to the profile using special techniques—for example welding, or using special tools, for example pressing. This mounting technology does not allow a repeated disassembly, is expensive and requires special equipment.

### SUMMARY OF THE INVENTION

These disadvantages are solved and eliminated by the mounting element according to the invention, the basis of which is that it consists of a body with a shoulder, where the body is provided with at least one lateral groove to form an elastic edge portion of the body; preferable are two lateral grooves. In the shoulder, at least one hole is created with a tapered run-out, which extends to the axis of each lateral groove. It is preferable if this hole is threaded. Then a mounting hole is formed in the shoulder to mount another structural component.

According to the invention it is preferable if the elastic edge portions of the body of the mounting element are roughened on the outer circumference or provided with splines to increase the strength of the shaped joint.

According to the invention it is also preferable if elastic edge portions of the body of the mounting element are provided on the outer circumference with hard surface to increase the strength of the shaped joint.

The mounting element operates on the principle of the opening of the body placed inside the metallurgical profile. The mounting element according to the invention has a sufficient clearance for an easy insertion of the body into the metallurgical profile. This clearance is eliminated by opening elastic edge portions of the body, and sufficient pressure is exerted to press-in edge portions of the body to the walls of the profile. The mounting element is of a geometric shape (usually a cube, cuboid or cylinder). The shoulder of the mounting element corresponds to the thickness of the profile wall, which serves as a supporting surface or a stop. The holes in the grooves may not contain only a thread; another variant of the embodiment may be, for example, a conical hole into which a conical insert (pin) is fitted instead of a screw. The outer surface of the shoulder of the mounting element may be used for different mounting holes, such as a central thread for mounting a wheel or an adjustable foot.

The body of the mounting element is loosely inserted into the metallurgical profile. Using expansion elements, which could be screws, cones and the like, and using a suitable tool, such as a screwdriver, the expansion element is tightened, located in the conically ended hole of the coupling, by which edge portions of the body of the mounting element at the end of the groove inside the profile expand and get partly pressed into the wall of the profile. For this purpose, the body of the mounting element can be provided with suitable surface treatment to increase hardness. The pulling out of the mounting element from the profile is prevented by a shaped joint formed in this way. To improve the resistance against pulling out, the wall of the plug could be suitably roughened, for example by transverse grooving, etc.

### BRIEF DESCRIPTION OF DRAWINGS

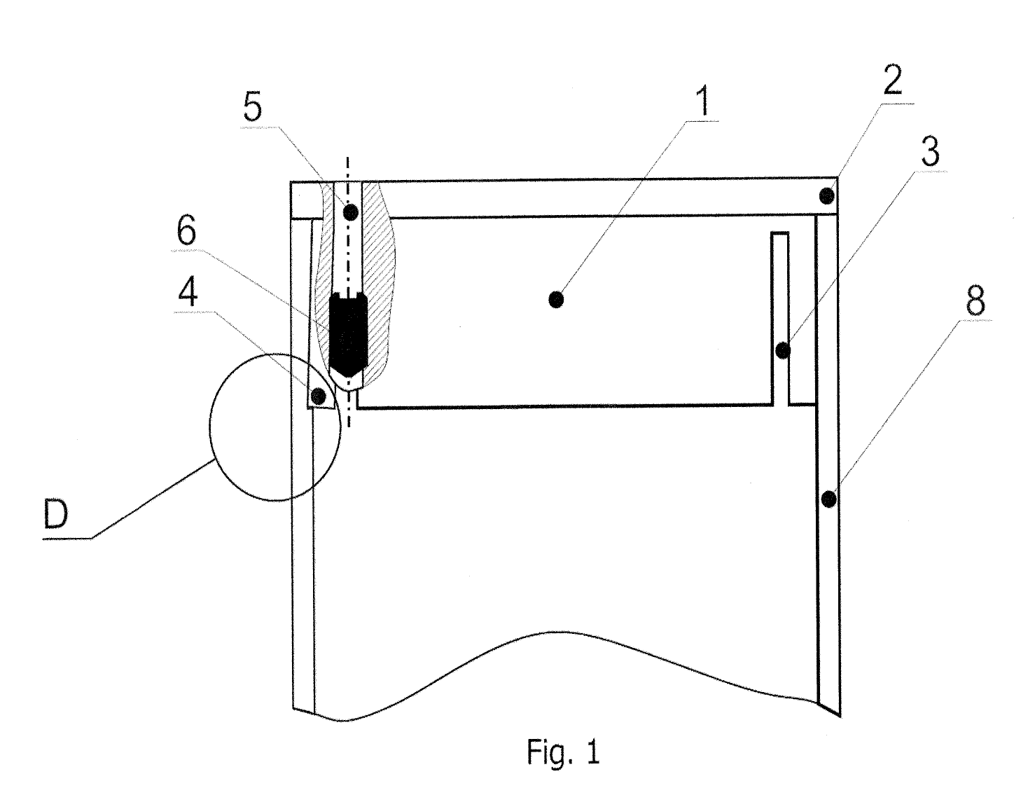

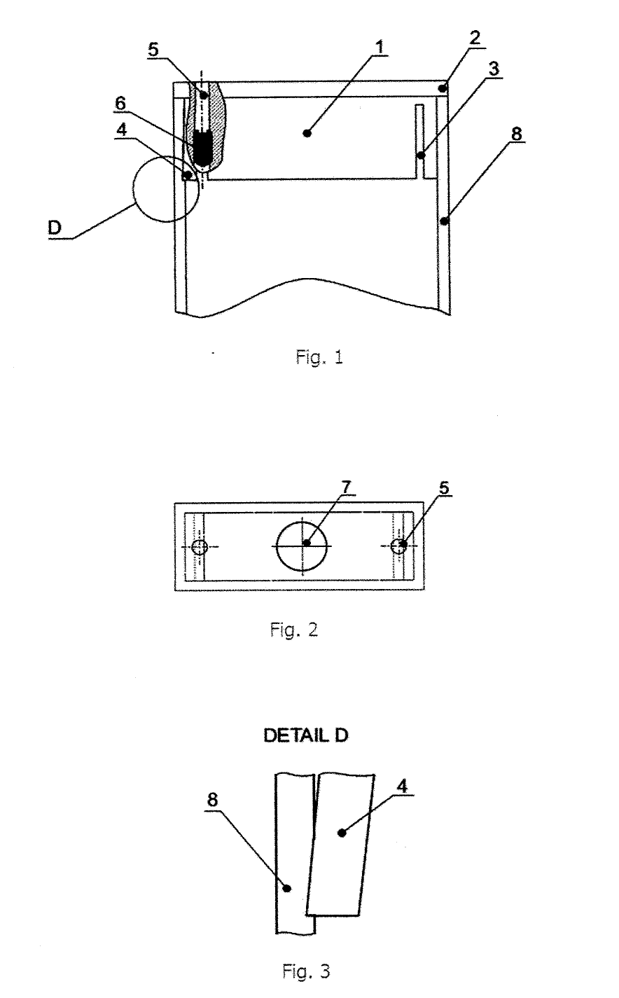

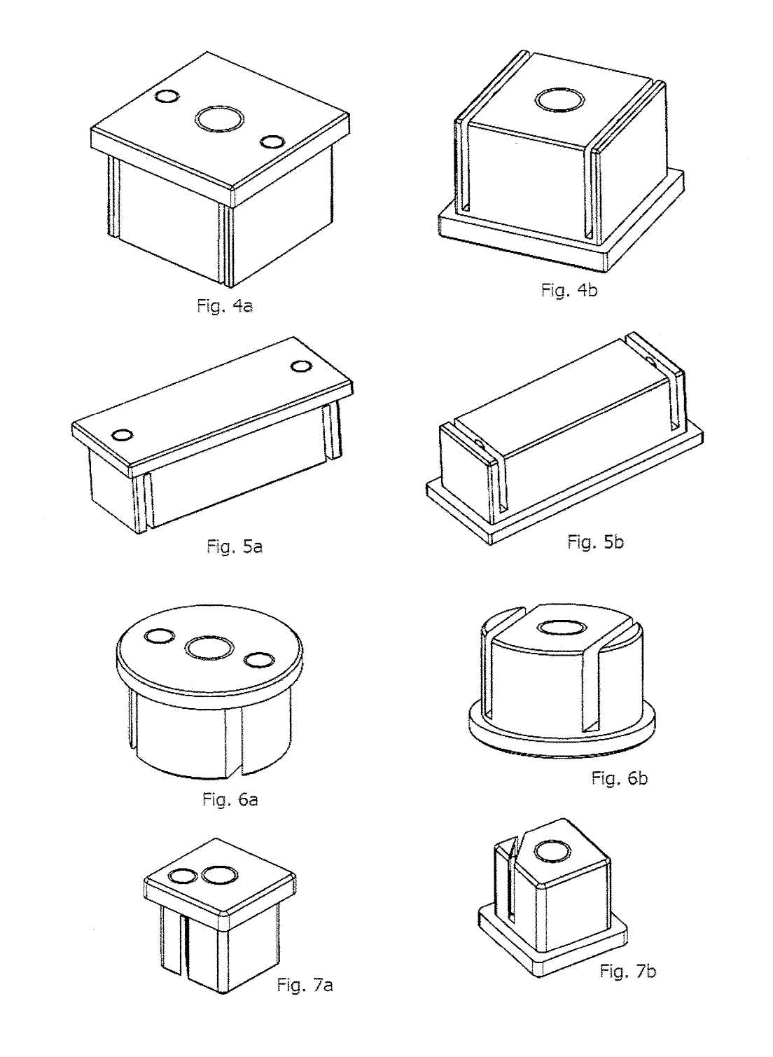

The invention will be further illustrated by the drawings, where: FIG. 1 contains a longitudinal axial sectional view of the assembly of the mounting element inserted into the rectangular metallurgical profile. FIG. 2 shows a plan view of the mounting element with holes for expansion elements; FIG. 3 is detail D of FIG. 1, where the bracing of the side wall of the mounting element in the metallurgical profile is visible, as well as the connection established by this, which is resistant to pulling out. FIGS. 4a, 4b, 5a, 5b, 6a, 6b a 7a, 7b show other possible variants of the mounting element according to the invention, always in two views, namely from the side of the shoulder and from the side of the mounting element's body.

### DESCRIPTION OF PREFERRED EMBODIMENTS

The mounting element according to the invention consists of body 1 and shoulder 2. Shoulder 2 forms a supporting surface and ensures the strength of the mounting element in the axis in the direction to metallurgical profile 8. On the side opposite to shoulder 2, body 1 is fitted with lateral grooves 3 which flexibly divide body 1 in a suitable manner to create deformable edge portions 4. Holes 5 are created in shoulder 2 to extend to the axis of lateral grooves 3. Holes 5 are either provided with a thread with a tapered run-out, or are of a conical shape. Body 1 of the mounting element is inserted into corresponding metallurgical profile 8. The actual bracing of edge portions 4 to the walls of metallurgical profile 8 is achieved after the insertion of expansion element 6, i.e. after screwing in the screw or after the pushing in of the conical pin, see detail D in FIG. 3, which ensures a shaped connection of body 1 of the mounting element and profile 8. In shoulder 2, preferably in its centre, mounting hole 7 is created for the attachment of another structural component, such as an adjustable foot, a wheel or another component that needs to be attached to profile 8.

### LIST OF REFERENCE NUMERALS

1—body of the mounting element
2—shoulder of the mounting element
3—lateral grooves of the body
4—edge portions of the body
5—holes in the grooves
6—expansion element
7—mounting hole
8—metallurgical profile

1. A mounting element, comprising a body with a shoulder, wherein the body is provided with at least one lateral groove to form a flexible edge portion of the body, wherein in the shoulder at least one hole is formed with a tapered run-out extending to the axis of the lateral groove and a mounting hole, while the at least one hole is designed for receipt of an expansion element and the mounting hole for the attachment of another structural component.

2. The mounting element according to claim 1, wherein the at least one hole (5) with the tapered run-out is threaded.

3. The mounting element according to claim 1, wherein flexible edge portions are roughened or provided with splines on the outer circumference to increase the strength of the shaped joint.

4. The mounting element according to claim 1, wherein the flexible edge portions are provided with a hard surface on the outer circumference to increase the strength of the shaped joint.

5. The mounting element according to claim 2, wherein the flexible edge portions are roughened or provided with splines on the outer circumference to increase the strength of the shaped joint.

6. The mounting element according to claim 2, wherein the flexible edge portions are provided with a hard surface on the outer circumference to increase the strength of the shaped joint.

7. The mounting element according to claim 1 further comprising the expansion element which is received in the at least one hole.
